(19) United States
(12) Patent Application Publication
(10) Pub. No.: US 2006/0266385 A1
(43) Pub. Date: Nov. 30, 2006

(54) Home appliance structure with integral noise attenuation

(75) Inventor: Michael J. Malaker, Waukegan, IL (US)

Correspondence Address: QUINN LAW GROUP, PLLC, 39555 ORCHARD HILL PLACE, SUITE # 520, NOVI, MI, 48375, US

(73) Assignee: MATERIAL SCIENCES CORPORATION

(21) Appl. No.: 11/138,975

(22) Filed: May 26, 2005

(51) Int. Cl. B08B 3/00; B08B 3/12

(52) U.S. Cl. 134/56 D; 134/184; 134/198

(57) ABSTRACT

A home appliance includes a panel forming one of a tub, drum, and a housing for the appliance. The panel includes a first metal layer, a second metal layer, and a viscoelastic layer between, and spanning the entireties of, the first and second metal layers. The viscoelastic layer is configured such that the panel exhibits a composite loss factor of at least 0.05. The panel therefore forms appliance structure with integral noise attenuation, which improves upon the prior art by reducing the number of parts and manufacturing steps necessary for add-on noise attenuators. Furthermore, since the viscoelastic layer spans the entirety of the metal layers, noise attenuation is continuous across the panel, unlike many prior art noise attenuators which provide only localized noise attenuation.

### TECHNICAL FIELD

This invention relates to home appliances including a panel with two metal layers and a viscoelastic layer therebetween spanning the entirety of both metal layers such that the panel exhibits a composite loss factor of at least 0.05.

### BACKGROUND OF THE INVENTION

Many home appliances include components that produce significant amounts of noise and vibration. For example, a household dishwasher includes an electric motor that drives a water pump, which produces noise and vibration. The pump forces water at high velocity through nozzles into a chamber, where the water acts on plates, glassware, etc., and contacts the inner surface of the chamber. When the water impacts the plates, glassware, and inner surface of the chamber, it produces unwanted noise and vibration.

Household clothes washing machines typically include a drum for containing clothes and water, and a motor to rotate the drum. The rotation of the drum produces significant noise and vibration, especially at high speeds during a rinse cycle and when the clothes are arranged so as to produce an unbalanced load. Household clothes dryers typically include a drum rotatable about a horizontal axis. The clothes tumble inside the drum, producing a significant amount of noise and vibration.

Prior art attempts to attenuate the noise and vibration produced by household appliances involve significant costs and disadvantages. For example, mastic PSAs are asphaltic patches that contain a pressure-sensitive adhesive (PSA) used to attach the patch to the appliance structure (such as a tub or housing). Heat activated mastic patches are typically placed on horizontal metal surfaces and bond to the surface with heat over a period of time. Mastics are typically nonrecyclable.

Metal or foil patches may include a pressure sensitive adhesive attached to a layer of metal foil or a metal sheet. The force requirements to adhere the metal or foil patch varies from light hand pressure to several hundred pounds, requiring the use of a machine or tool.

Mastic PSAs, heat activated mastic patches, and metal or foil patches require additional labor and equipment to install, result in acoustic variation from article to article because of variation in placement location, and have only localized damping coverage limited to the area covered by the damping material.

Spray-on bitumen may be applied to the structure of a home appliance. The bitumen must be baked in order to cure, and may require multiple applications to achieve the desired coating thickness. The bitumen is nonrecyclable, may require additional labor and/or equipment to install, involves increased energy costs due to the baking process, and results in unwanted fumes during application and curing.

Felt/fiber patches or blankets may be applied to metal appliance structures, requiring fasteners, additional labor, and inferior noise, vibration, and harshness characteristics. Foams may also be applied to metal appliance structure, typically by being sprayed on. Foams may also be injection molded in a die into the desired shape. Foams require additional labor and/or equipment and result in only localized damping coverage.

Accordingly, prior art attempts to reduce the noise, vibration, and harshness of home appliances are labor-intensive, increase cost, and provide damping only in the area in which they are applied.

### SUMMARY OF THE INVENTION

A home appliance is provided that includes a panel forming at least a portion of the appliance. The panel has two metal layers and a viscoelastic layer therebetween spanning the entirety of both metal layers. The viscoelastic layer is configured such that the panel exhibits a composite loss factor of at least 0.05.

According to one aspect of the invention, the panel at least partially defines a tub for a dishwasher and exhibits a composite loss factor of at least 0.05 between 40° F. and 150° F. to attenuate noise incurred by the spray action of water on the tub. According to another aspect of the invention, the panel at least partially forms a housing or tub of a clothes washing machine and exhibits a composite loss factor of at least 0.05 between 40° F. and 150° F. According to yet another aspect of the invention, the panel forms at least a portion of a drum or housing of a clothes dryer and exhibits a composite loss factor of at least 0.05 between 80° F. and 250° F.

The panel provides noise attenuation at every point on its surface, as opposed to the prior art, which provides only localized noise attenuation. The panel also provides noise attenuation that is integral to the structure of the appliance, which results in a reduction of parts and manufacturing steps compared to the prior art. The panel is also recyclable.

According to yet another aspect of the invention, one of the metal layers has a metal composition different from the other metal layer, enabling improved aesthetics on one side of the panel while optimizing cost, strength, or other characteristics on the other side of the panel.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, cross-sectional view of a laminated panel structure;

FIG. 2 is a schematic, perspective view of a dishwasher including a tub having the laminated panel structure of FIG. 1;

FIG. 3 is a graph depicting the relationship between composite loss factor and temperature for two exemplary formulations of the viscoelastic layer of the laminated panel of FIG. 1;

FIG. 4 is a schematic, perspective view of a washing machine including a tub and housing having the laminated panel structure of FIG. 1; and

FIG. 5 is a schematic, perspective view of a clothes dryer including a drum and housing having the laminated panel structure of FIG. 1.

### DESCRIPTION OF THE PREFERRED EMBODIMENTS

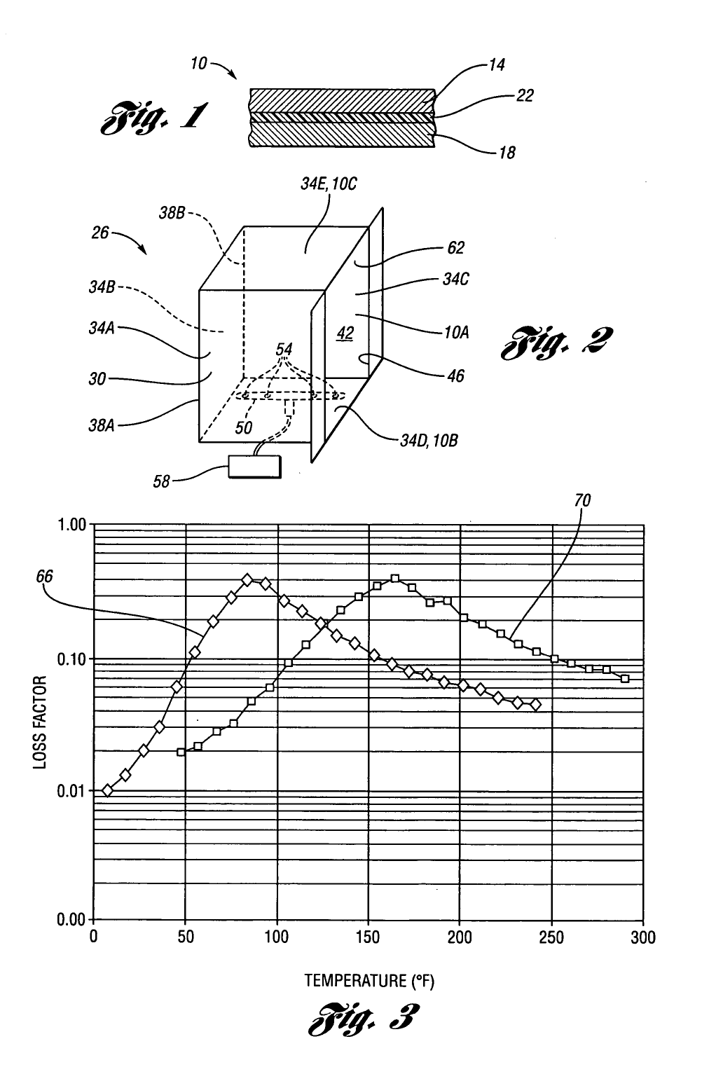

Referring to FIG. 1, a cross-section of a panel 10 is schematically depicted. The panel 10 is a laminated sheet structure which includes a first metal layer 14 and a second metal layer 18. A viscoelastic layer 22 is disposed between, and spans the entirety of, the first metal layer 14 and the second metal layer 18. Referring to FIG. 2, a portion of a dishwasher 26 is schematically depicted. The dishwasher 26 includes a tub 30 having five generally planar sides 34A-E. Sides 34A, 34B, and 34C are formed from a single panel 10A that is bent at creases 38A, 38B. Side 34D is formed by panel 10B, and side 34E is formed by panel 10C. Panels 10B and 10C are connected to panel 10A such that the sides 34A-E define a dishwashing chamber 42 having an opening 46. As shown in FIG. 2, panel 10A defines two flanges on opposite sides of opening 46. A door (not shown) is pivotably connected with respect to the tub 30 to selectively obstruct and seal the opening 46. Those skilled in the art will recognize a variety of methods for operatively connecting panels 10B and 10C to panel 10A, such as welding, mechanical fasteners such as bolts, adhesive bonding, etc.

The dishwasher 26 also includes a spray arm 50 with a plurality of holes or nozzles 54 thereon within the chamber 42. A pump 58 is in fluid communication with the nozzles 54 and is configured to selectively supply pressurized water to the chamber 42 through the nozzles 54. The nozzles 54 are directed generally upward to spray water on dishes, glassware, etc., on racks (not shown) within the chamber 42, as understood by those skilled in the art. Some of the spray from the nozzles 54 will impact the inner surface 62 of the tub 30. In prior art tubs, the spray impacting the tub causes excessive noise and vibration, which is particularly undesirable when the dishwasher is used in homes.

Panels 10A, 10B, and 10C are entirely formed of the laminated panel structure shown at 10 in FIG. 1. Thus, one side of each panel 10A, 10B, 10C is formed of a respective first metal layer, the other side of each panel 10A, 10B, 10C is formed of a respective second metal layer, and each first metal layer is separated from the corresponding second metal layer by a viscoelastic layer that spans the entirety of the respective first and second metal layers.

Referring again to FIG. 1, it may be desirable for the metal layers 14, 18 to have different metal compositions. For example, the first metal layer 14 may be aluminum, stainless steel, etc., to provide the inner surface of the tub with an aesthetically pleasing appearance, and the second metal layer 18 may be hot dip galvanized steel to provide the panel with strength at low cost. Furthermore, it may be desirable for the metal layers 14, 18 to have different thicknesses. For example, the first metal layer 14 may be thinner than the second metal layer 18; thus, for example, if the first metal layer 14 is aluminum or stainless steel and the second metal layer 18 is steel, the second metal layer may be thicker than the first metal layer so that less aluminum or stainless steel is employed in the construction of the panel 10, with resultant cost savings.

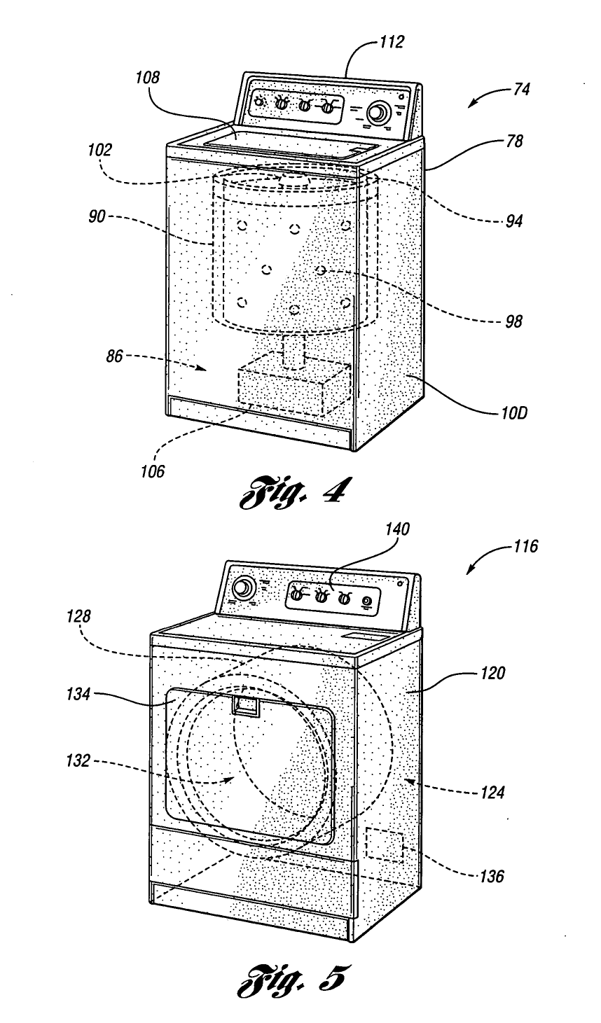

Referring to FIG. 3, the relationship between composite loss factor and temperature for two exemplary viscoelastic layer formulations are schematically depicted. Line 66 depicts the composite loss factor of a panel with a first viscoelastic layer formulation as a function of temperature. With the first viscoelastic layer formulation, the panel exhibits a composite loss factor of approximately 0.01 at 0° F., 0.40 at approximately 70° F., and approximately 0.06 at 200° F. Furthermore, with the first viscoelastic layer formulation, the panel exhibits a composite loss factor of at least 0.05 (i.e., 5 percent) at all temperatures between approximately 40° F. and approximately 220° F., and the panel exhibits a composite loss factor of at least 0.10 (i.e., 10 percent) at all temperatures between approximately 55° F. and approximately 160° F., as shown by line 66.

Line 70 depicts the composite loss factor of a panel with a second viscoelastic layer formulation as a function of temperature. With the second viscoelastic layer formulation, the panel exhibits a composite loss factor of approximately 0.02 at 50° F., 0.40 at approximately 160° F., and approximately 0.20 at 200° F. Furthermore, with the second viscoelastic layer formulation, the panel exhibits a composite loss factor of at least 0.05 at all temperatures between approximately 80° F. and approximately 280° F., and the panel exhibits a composite loss factor of at least 0.10 at all temperatures between approximately 110° F. and approximately 250° F., as shown by line 70.

Referring again to FIGS. 1 and 2, the viscoelastic layer 22 is the first viscoelastic layer formulation such that the composite loss factor of the panels 10A, 10B, 10C is a function of temperature as shown by line 66 of FIG. 3, which provides superior noise attenuation under dishwasher operating conditions. Since the laminated panel structure shown in FIG. 1 is coextensive with the entire tub 30, noise attenuation is provided at every point on the inner surface 62 of the chamber 42.

Referring to FIG. 4, a clothes washing machine 74 is schematically depicted. The washing machine 74 includes a housing 78 defined by one or more panels 10D. The housing 78 defines a compartment 86 containing a generally cylindrical outer tub 90 and an inner tub 94 (sometimes referred to as a “basket”) disposed within the outer tub 90. The inner tub 94 defines a plurality of holes 98, and an agitator 102 is disposed within the inner tub 94. A motor 106 is operatively connected to the inner tub 94 to selectively cause the rotation thereof with respect to the outer tub 90, and to cause movement of the agitator 102, as understood by those skilled in the art. In operation, the inner tub 94 is filled with clothes through an opening covered by lid 108, and the outer tub 90 is filled with water, which also fills the inner tub 94 through holes 98. The motor 106 drives the agitator 102 during a wash cycle, and the motor 106 rotates the inner tub 94 to remove water from the clothes contained therein. A control panel 112 is provided to control the operation of the machine.

The housing 78 and the outer tub 90 are formed entirely by the laminated panel structure depicted in FIG. 1, and include the first viscoelastic layer formulation such that the composite loss factor of the housing 78 and outer tub 90 is a function of temperature as shown by line 66 of FIG. 3, which provides superior noise attenuation under clothes washing machine operating conditions.

Referring to FIG. 5, a clothes dryer 116 is schematically depicted. The clothes dryer 116 includes a housing 120 defining a compartment 124. A drum 128 is located within the compartment 124 and defines a generally cylindrical chamber 132 for containing clothes (not shown). The chamber 132 is accessible through an opening in the housing 120 obstructed by door 134. A motor 136 is operatively connected to the drum 128 to cause the rotation thereof. The rotation of the drum causes clothes contained therein to tumble, and heat is applied to facilitate drying, as understood by those skilled in the art. Within the scope of the claimed invention, a “generally cylindrical” chamber may or may not include paddles extending radially inward to assist movement of the clothes. The drum 128 and the housing 120 are formed entirely of the laminated panel structure depicted in FIG. 1, and the viscoelastic layer is characterized by the second viscoelastic layer formulation such that the composite loss factor of the drum 128 and housing 120 is a function of temperature as shown by line 70 in FIG. 3, which provides superior noise attenuation for clothes dryer operating conditions. A control panel 140 controls the operation of the dryer 116.

In an alternative embodiment, the panels 10A, 10B, 10C of FIG. 2, the housing 78 and tub 90 of FIG. 4, and the housing 120 and drum 128 of FIG. 5 are characterized by a composite loss factor of at least 0.05 at all temperatures between 40° F. and 200° F.

While the best modes for carrying out the invention have been described in detail, those familiar with the art to which this invention relates will recognize various alternative designs and embodiments for practicing the invention within the scope of the appended claims.

1. An appliance comprising:
a panel forming at least one of a tub, drum and housing of the appliance, the panel having two metal layers and a viscoelastic layer therebetween spanning the entirety of both of the two metal layers;
wherein the panel exhibits a composite loss factor of at least 0.05.

2. The appliance of claim 1, wherein the two metal layers include a first metal layer and a second metal layer; wherein the first metal layer is characterized by a first metal composition; and wherein the second metal layer is characterized by a second metal composition different from the first metal composition.

3. The appliance of claim 2, wherein the first metal layer is characterized by a first thickness, and wherein the second metal layer is characterized by a second thickness greater than the first thickness.

4. The appliance of claim 1, wherein the appliance is a dishwasher; and wherein the panel defines at least a portion of a tub defining a dishwashing chamber.

5. The appliance of claim 4, wherein the panel exhibits a composite loss factor of at least 0.05 between 40° F. and 150° F.

6. The appliance of claim 4, wherein the panel exhibits a composite loss factor of at least 0.10 between 60° F. and 120° F.

7. The appliance of claim 6, wherein the panel exhibits a composite loss factor of at least 0.10 between 60° F. and 140° F.

8. The appliance of claim 6, wherein the panel exhibits a composite loss factor of at least 0.10 between 60° F. and 160° F.

9. The appliance of claim 4, further comprising a nozzle positioned within the chamber, and a pump in fluid communication with the nozzle for selectively directing pressurized water into the chamber through the nozzle.

10. The appliance of claim 1, wherein the appliance is a clothes washing machine; and wherein the appliance further comprises an outer tub, an inner tub disposed within the outer tub and defining a plurality of apertures, a motor operatively connected to the inner tub to selectively cause the rotation thereof; and a housing defining a compartment containing the inner tub, the outer tub, and the motor; and
wherein the panel at least partially defines one of the housing and the outer tub.

11. The appliance of claim 10, wherein the panel exhibits a composite loss factor of at least 0.05 between 40° F. and 150° F.

12. The appliance of claim 10, wherein the panel exhibits a composite loss factor of at least 0.10 between 60° F. and 120° F.

13. The appliance of claim 12, wherein the panel exhibits a composite loss factor of at least 0.10 between 60° F. and 140° F.

14. The appliance of claim 12, wherein the panel exhibits a composite loss factor of at least 0.10 between 60° F. and 160° F.

15. The appliance of claim 1, wherein the appliance is a clothes dryer; wherein the appliance further comprises a drum defining a generally cylindrical chamber, a motor operatively connected to the drum and configured to selectively cause rotation of the drum, and a housing defining a compartment in which the drum and motor are contained; and wherein the panel at least partially defines one of the drum and the housing.

16. The appliance of claim 15, wherein the panel exhibits a composite loss factor of at least 0.05 between 80° F. and 250° F.

17. The appliance of claim 15, wherein the panel exhibits a composite loss factor of at least 0.10 between 110° F. and 200° F.

18. The appliance of claim 15, wherein the panel exhibits a composite loss factor of at least 0.10 between 110° F. and 250° F.

19. A dishwasher comprising:
a tub having five sides defining a dishwashing chamber;
a nozzle disposed within the dishwashing chamber;
a pump in fluid communication with the nozzle;
wherein each of the five sides is characterized by a laminated panel structure including a first metal layer, a second metal layer, and a viscoelastic layer between and spanning the entirety of the first and second metal layers; and
wherein the tub is characterized by a composite loss factor of at least 0.05 between the temperatures of 40° F. and 170° F.

20. The dishwasher of claim 19, wherein the dishwasher is characterized by the absence of noise attenuation members contacting the tub.
